(19) United States
(12) Patent Application Publication
(10) Pub. No.: US 2011/0231912 A1
(43) Pub. Date: Sep. 22, 2011

(54) SYSTEM, METHOD AND COMPUTER PROGRAM PRODUCT FOR AUTHENTICATING A MOBILE DEVICE USING AN ACCESS TOKEN

(75) Inventors: Jong Lee, Pleasanton, CA (US); Erik Forsberg, Los Angeles, CA (US)

(73) Assignee: SALESFORCE.COM, INC., San Francisco, CA (US)

(21) Appl. No.: 12/968,209

(22) Filed: Dec. 14, 2010

Related U.S. Application Data
(60) Provisional application No. 61/315,777, filed on Mar. 19, 2010.

(51) Int. Cl. H04L 9/32; G06F 21/00

(52) U.S. Cl. 726/7

(57) ABSTRACT

In accordance with embodiments, there are provided mechanisms and methods for authenticating a mobile device using an access token. These mechanisms and methods for authenticating a mobile device using an access token can provide authentication in an automated manner. The ability to provide authentication in an automated manner can enable repeated access to data by a user without requiring an associated repetitive manual authentication by the user.

### CLAIM OF PRIORITY

This application claims the benefit of U.S. Provisional Patent Application 61/315,777 entitled “Mobile Device Token Authentication In A Multitenant Environment,” by Lee et al., filed Mar. 19, 2010 (Attorney Docket No. SEC1P089+/269PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to authentication for data access.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Traditionally, user authentication for data access has been implemented for securing access to data. For example, a user is typically required to input a username and password which authenticates the user prior to allowing the user access to the content. Unfortunately, conventional techniques providing authentication for data access have exhibited various limitations. Just by way of example, a user is typically required to enter a username and password each time the user attempts to access the data requiring the authentication, thus requiring repetitive manual input by the user.

Accordingly, it is desirable to provide techniques enabling more automated authentication with respect to data access.

### BRIEF SUMMARY

In accordance with embodiments, there are provided mechanisms and methods for authenticating a mobile device using an access token. These mechanisms and methods for authenticating a mobile device using an access token can enable embodiments to provide authentication in an automated manner The ability of embodiments to provide authentication in an automated manner can enable repeated access to data by a user without requiring an associated repetitive manual authentication by the user.

In an embodiment and by way of example, a method for authenticating a mobile device using an access token is provided. In use, a request to access content is received from a mobile device. Additionally, an access token stored on the mobile device is automatically identified, based on the request. Further, the mobile device is authenticated for accessing the content, using the access token.

While one or more implementations and techniques are described with reference to an embodiment in which authenticating a mobile device using an access token is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by BM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for authenticating a mobile device using an access token, in accordance with an embodiment;

FIG. 2 illustrates a system for providing an access token to a mobile device, in accordance with an embodiment;

FIG. 3 illustrates a system for using an access token stored on a mobile device to establish a data access session with the mobile device, in accordance with an embodiment;

FIG. 4 illustrates a block diagram of an example of an environment wherein an on-demand database service might be used; and

FIG. 5 illustrates a block diagram of an embodiment of elements of FIG. 4 and various possible interconnections between these elements.

### DETAILED DESCRIPTION

### General Overview

Systems and methods are provided for authenticating a mobile device using an access token.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing authenticating a mobile device using an access token will be described with reference to example embodiments.

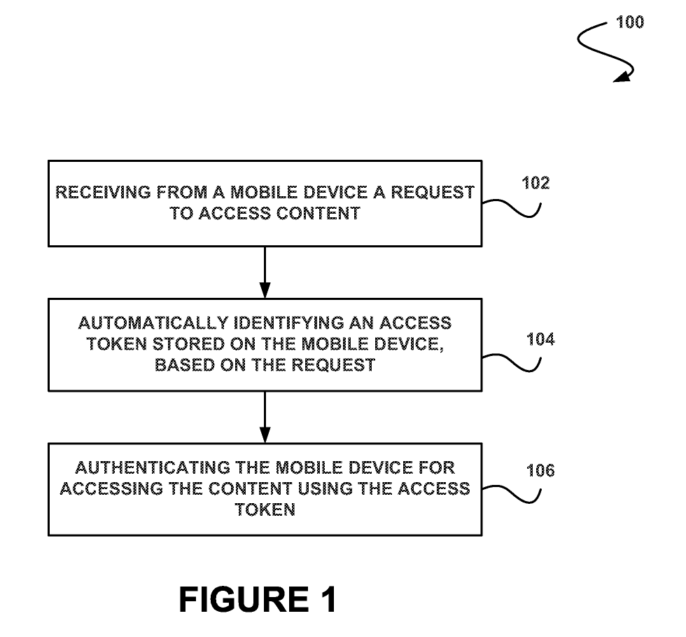

FIG. 1 illustrates a method for authenticating a mobile device using an access token, in accordance with an embodiment. As shown in operation 102, a request to access content is received from a mobile device. With respect to the present description, the content includes any data that is accessible by a mobile device. For example, the content may be an application, a file, a database, a webpage, etc.

In one embodiment, the content may be stored by a multi-tenant on-demand database system for access by at least one tenant of such multi-tenant on-demand database system. Thus, the mobile device may optionally be owned, operated, etc. by a user that is a tenant of the multi-tenant on-demand database system. Of course, it should be noted that such mobile device may include any device capable of being utilized to access the content that is mobile in nature, such as a mobile phone, laptop, personal digital assistance (PDA), etc.

As noted above, a request to access the content is received from the mobile device. Such access may include reading the content, receiving the content, utilizing (e.g. interacting with) the content, etc. Thus, the mobile device may transmit the request to allow the mobile device to gain access to the content.

In one embodiment, the request may include, or otherwise be in the form of, a uniform resource locator (URL). For example, the URL may indicate the content (e.g. a name of the content or other identifier of the content). Of course, however, the request may include any type of request that indicates the content to which access is being requested.

Additionally, as shown in operation 104, an access token stored on the mobile device is automatically identified, based on the request. With respect to the present description, the access token may include any object capable of being utilized to authenticate the mobile device, as described below in more detail. Just by way of example, the access token may be utilized for authenticating the mobile device in lieu of a username and password being utilized for the authentication.

In one embodiment, the access token may be uniquely associated with the mobile device. For example, the access token may be generated for the mobile device during a registration of the mobile device (e.g. with a multi-tenant on-demand database system storing the content). To this end, the access token may be uniquely associated with the mobile device such that the mobile device may be authenticated via the access token.

In another embodiment, the access token may include an identifier of a location of the content. Just by way of example, such location may include a server on which a plurality of different content is stored for access by the mobile device. In the context of the multi-tenant on-demand database system described above, the location may be a device of the multi-tenant on-demand database system storing content for the tenant associated with the mobile device. Optionally, the identifier of the location may be encrypted, such that at least a portion of the access token is encrypted.

In yet another embodiment, the access token may be included with the request, such that the access token may be automatically identified from the request. For example, the mobile device may store the access token in memory of the mobile device, and my send a copy of the access token with requests to access content. Of course, the access token may be identified as a result of the request in any manner that is automatic (e.g. without manual input of the access token by a user of the mobile device with respect to the request, etc.).

Further, as shown in operation 106, the mobile device is authenticated for accessing the content, using the access token. In the present description, the authentication may include identifying the mobile device (or user thereof) from which the request was received. Thus, where the access token is uniquely associated with the mobile device, the access token may be directly utilized to authenticate the mobile device.

As noted above, the authentication may be performed for allowing the mobile device to access the content. In one embodiment, the mobile device from which the request was received may be identified by way of the authentication, for subsequently determining whether such identified mobile device is permitted to access the content. For example, it may be determined whether the there are permissions established allowing the mobile device to access the content.

In another embodiment, the mobile device from which the request was received may be identified by way of the authentication, for subsequently determining a location of the content that is associated with the mobile device. In the example noted above where the access token includes the identifier of the location of the content, the authentication may include identifying the identifier of the location of the content from the access token. Thus, by identifying the location of the content that is associated with the mobile device, the mobile device may be provided access to the content at such location.

Just by way of example, the request may be forwarded to the location at which the content is stored (e.g. as determined using the access token), in response to the authentication. Accordingly, a device at the location may receive the request such that it may be allowed to provide a response to the request to the mobile device. By using an access token stored at the mobile device to authenticate the mobile device, the mobile device may be authenticated in an automated manner. Thus, a need for a user of the mobile device to enter a username and password each time the user desires to access content may be avoided.

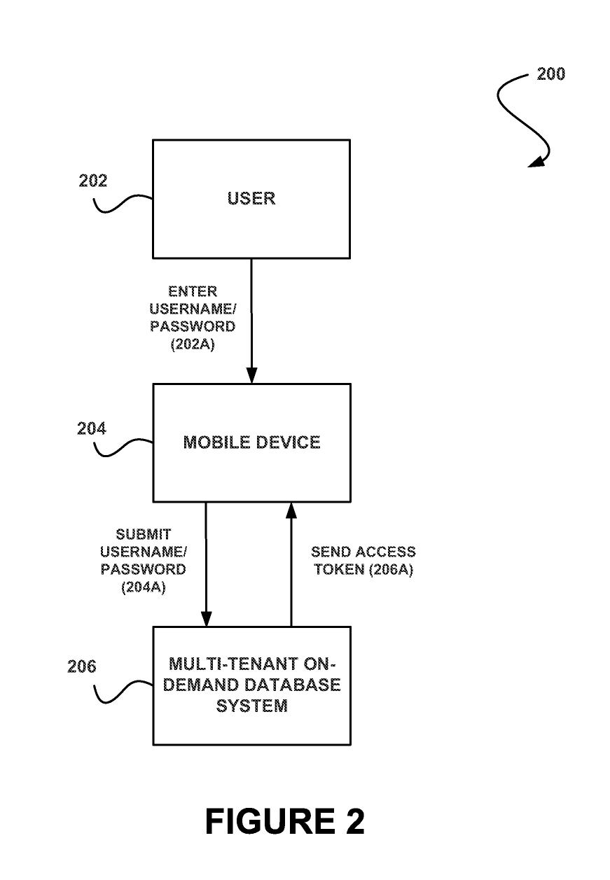

FIG. 2 illustrates a system 200 for providing an access token to a mobile device, in accordance with an embodiment. As an option, the system 200 may be implemented in the context of the architecture and environment of FIG. 1. Of course, however, the system 200 may be implemented in any desired environment.

As shown, a user 202 utilizes a mobile device 204 to communicate with a multi-tenant on-demand database system 206. For example, the mobile device 204 and the multi-tenant on-demand database system 206 may be in communication via a network (e.g. the Internet). It should be noted that while a multi-tenant on-demand database system 206 is shown, the mobile device 204 may be in communication with any system storing content that is accessible by a mobile device 204.

During registration of the mobile device 204 with the multi-tenant on-demand database system 206, a user of the mobile device 204 enters into the mobile device 204 a username and password of the user (see operation 202A). The username and password may include login information unique to the user 202 with respect to the multi-tenant on-demand database system 206. For example, the user 202 may be associated with a tenant of the multi-tenant on-demand database system 206, and the username and password may be capable of being utilized for authenticating the user 202 to the multi-tenant on-demand database system 206 (e.g. as a tenant of the multi-tenant on-demand database system 206).

In response to receipt of the username and password, the mobile device 204 submits the username and password to the multi-tenant on-demand database system 206 (see operation 204A). It should be noted that the mobile device 204 may also optionally submit additional information associated with the mobile device 204, such as a manufacturer, version, configuration, service provider, etc. of the mobile device 204). As a further option, the mobile device 204 may receive the username and password utilizing an application (e.g. with a graphical user interface) stored on the mobile device 204, and may further submit the username and password to the multi-tenant on-demand database system 206 utilizing such application. In one exemplary embodiment, the application may include the Mobile CRM application from Salesforce.com™.

While not shown, it should be noted that a mobile server may be situated between the mobile device 204 and multi-tenant on-demand database system 206 for proxying communications between the mobile device 204 and multi-tenant on-demand database system 206. For example, the mobile device 204 may submit the username and password to the multi-tenant on-demand database system 206 via a mobile server.

Upon receipt of the username and password, the multi-tenant on-demand database system 206 creates an access token for the mobile device 204. The access token may be uniquely created for the mobile device 204, such that the access token may be capable of authenticating the mobile device 204 (e.g. from other mobile devices). In one embodiment, the access token may include an identifier of a location on which content is stored for access by the mobile device 204. For example, the access token may include an identifier of a server or database of the multi-tenant on-demand database system 206 which stores content for a tenant (of the multi-tenant on-demand database system 206) with which the user 202 is associated.

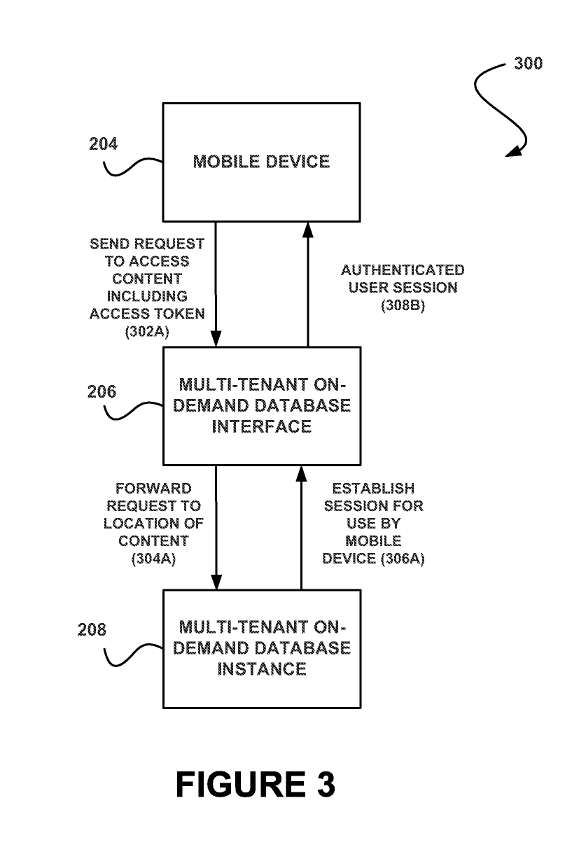

Further, the multi-tenant on-demand database system 206 sends such access token to the mobile device 204 (see operation 206A) for storage thereof by the mobile device 204. To this end, registration of the mobile device 204 may be completed once the access token 206A is sent to the mobile device 204 for storage. Such registration may allow the mobile device 204 to utilize the access token to access content stored by the multi-tenant on-demand database system 206, as described in more detail below with respect to FIG. 3.

As an option, the access token may be revoked from use by (e.g. removed from) the mobile device 204. For example, if the mobile device 204 is lost or inactive, an administrative user of the tenant with which the mobile device 204 is associated may revoke the access token, such that access by the mobile device 204 to content stored by the multi-tenant on-demand database system 206 may be denied. In one embodiment, the administrative user can use a setup page (UI) to revoke the access token as a security protection for unwanted and un-authorized access to content stored by the multi-tenant on-demand database system 206 by the mobile device 204.

FIG. 3 illustrates a system 300 for using an access token stored on a mobile device to establish a data access session with the mobile device, in accordance with an embodiment. As an option, the system 300 may be implemented in the context of the architecture and environment of FIGS. 1-2. Of course, however, the system 300 may be implemented in any desired environment.

As described above, a mobile device 204 is in communication with a multi-tenant on-demand database service 206. The mobile device 204 stores an access token generated for the mobile device 204 by the multi-tenant on-demand database service 206 during registration of the mobile device 204. In the present embodiment, the access token is unique associated with the mobile device 204 for use in authenticating the mobile device 204 to the multi-tenant on-demand database service 206, as described below.

Initially, the mobile device 204 sends a request to access content, including the access token, to the multi-tenant on-demand database service 206 (see operation 302A). In one embodiment, the request to access content may include a request to access an application stored by the multi-tenant on-demand database service 206. Of course, however, the content requested to be accessed may include any type of content that is accessible to the mobile device 204.

In another embodiment, the request may be in the form of a URL. For example, the URL may identify the content requested to be accessed. Thus, the mobile device 204 may submit the URL to the multi-tenant on-demand database service 206 via a browser of the mobile device 204.

As noted above, the request is sent with the access token. In one embodiment, the access token may be included in the URL. In another embodiment, the access token may be sent separately from the URL.

Upon receipt of the request and the access token, the multi-tenant on-demand database service 206 authenticates the mobile device 204 using the access token. In one embodiment, the authentication may be automatic by virtue of receipt of the access token. In this way, the mobile device 204 may be authenticated without necessarily requiring a username and password to be provided by the mobile device 204.

In another embodiment, the authentication may further include identifying a location indicated by the access token. For example, where the access token is encrypted, the access token may be decrypted for identifying the location. As described above, such location may include a location (e.g. server, database, etc.) of the multi-tenant on-demand database service 206 on which content is stored for access by the mobile device 204.

To this end, the request (e.g. URL) may identify the content and the access token may identify a location of the content. The multi-tenant on-demand database service 206 then forwards the request to the location of the content (note operation 304A). As shown in the present embodiment, the location of the content is an instance 208 of the multi-tenant on-demand database service 206. As described above, such instance 208 may include a server or database on which content is stored for, or that is otherwise specific to, a tenant of the multi-tenant on-demand database service 206.

In response to receipt of the request by the instance 208, the instance 208 establishes a session for use by the mobile device 204 (see operation 306A). Furthermore, the multi-tenant on-demand database service 206 receives the established session and forwards the session to the mobile device 204 as an authenticated user session (see operation 308A). The session may include any communication session with the mobile device 204 via which a response to the request may be sent from the instance 208 to the mobile device 204. For example, the content requested to be accessed by the mobile device 204 may be provided to the mobile device 204 by the instance 208 via the session.

### System Overview

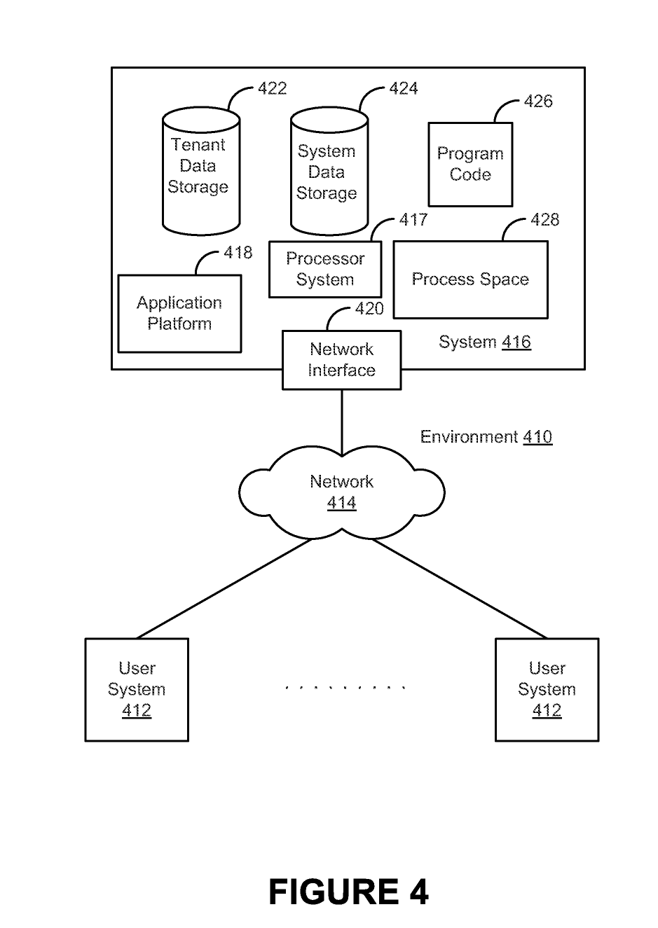

FIG. 4 illustrates a block diagram of an environment 410 wherein an on-demand database service might be used. Environment 410 may include user systems 412, network 414, system 416, processor system 417, application platform 418, network interface 420, tenant data storage 422, system data storage 424, program code 426, and process space 428. In other embodiments, environment 410 may not have all of the components listed and/or may have other elements instead of, or in addition to, those listed above.

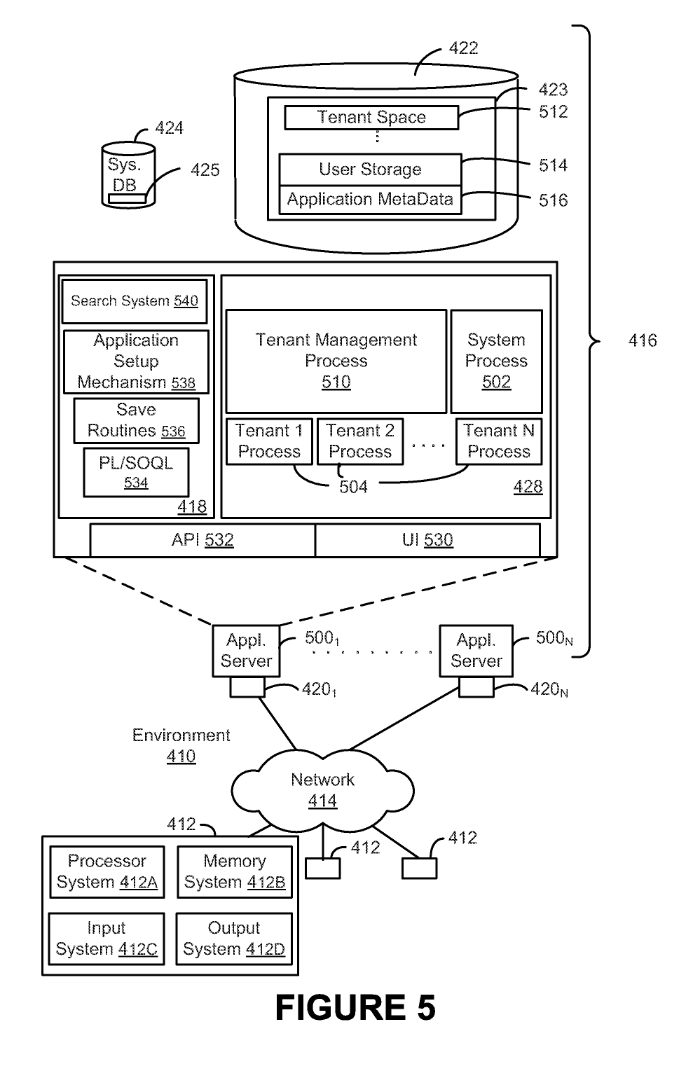

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in FIG. 4 (and in more detail in FIG. 5) user systems 412 might interact via a network 414 with an on-demand database service, which is system 416.

An on-demand database service, such as system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, on-demand database service 416″ and “system 416” will be used interchangeably herein. A database image may include one or more database objects. A relational database management system (RIMS) or the equivalent may execute storage and retrieval of information against the database object(s). Application platform 418 may be a framework that allows the applications of system 416 to run, such as the hardware and/or software, e.g., the operating system. In an embodiment, on-demand database service 416 may include an application platform 418 that enables creation, managing and executing one or more applications developed by the provider of the on-demand database service, users accessing the on-demand database service via user systems 412, or third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 412 might communicate with system 416 using TCP/IP and, at a higher network level, use other common Internet protocols to communicate, such as HTTP, FTP, AFS, WAP, etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as provide related data, code, forms, webpages and other information to and from user systems 412 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 416 implements applications other than, or in addition to, a CRM application. For example, system 416 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of system 416 is shown in FIG. 4, including a network interface 420, application platform 418, tenant data storage 422 for tenant data 423, system data storage 424 for system data 425 accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventional, well-known elements that are explained only briefly here. For example, each user system 412 could include a desktop personal computer, workstation, laptop, PDA, cell phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser. Netscape's Navigator browser, Opera's browser, or a WAP-enabled browser in the case of a cell phone, PDA or other wireless device, or the like, allowing a user (e.g., subscriber of the multi-tenant database system) of user system 412 to access, process and view information, pages and applications available to it from system 416 over network 414. Each user system 412 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where inure than one is present) and all of their components might be operator configurable using application(s) including computer code to run using a central processing unit such as processor system 417, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 416 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 416 is configured to provide webpages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 410. However, in FIG. 5 elements of system 416 and various interconnections in an embodiment are further illustrated. FIG. 5 shows that user system 412 may include processor system 412A, memory system 41213, input system 412C, and output system 412D. FIG. 5 shows network 414 and system 416. FIG. 5 also shows that system 416 may include tenant data storage 422, tenant data 423, system data storage 424, system data 425, User Interface (UI) 530, Application Program Interface (API) 532, PL/SOQL 534, save routines 536, application setup mechanism 538, applications servers 500₁-500_{N}, system process space 502, tenant process spaces 504, tenant management process space 510, tenant storage area 512, user storage 514, and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 4, Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackballs, scanners, cameras, and/or interfaces to networks. Output system 412D may be any combination of output devices, such as one or more monitors, printers, and/or interfaces to networks. As shown by FIG. 5, system 416 may include a network interface 420 (of FIG. 4) implemented as a set of HTTP application servers 500, an application platform 418, tenant data storage 422, and system data storage 424. Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data. Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 530 provides a user interface and an API 532 provides an application programmer interface to system 416 resident processes to users and/or developers at user systems 412. The tenant data and the system data may be stored in various databases, such as one or more Oracle™ databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510 for example. Invocations to such applications may be coded using PL/SOQL 534 that provides a programming language style interface extension to API 532. A detailed description of some PL/SOQL language embodiments is discussed in commonly owned U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 516 for the subscriber making the invocation and executing the metadata as an application in a virtual machine.

Each application server 500 may be communicably coupled to database systems, e.g., having access to system data 425 and tenant data 423, via a different network connection. For example, one application server 500₁ might be coupled via the network 414 (e.g., the Internet), another application server 500_{N-1} might be coupled via a direct network link, and another application server 500_{N} might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles storage of, and access to, different objects, data and applications across disparate users and organizations.

As an example of storage, one tenant might be a company that employs a sales force where each salesperson uses system 416 to manage their sales process. Thus, a user might maintain contact data, leads data, customer follow-up data, performance data, goals and progress data, etc., all applicable to that user's personal sales process (e.g., in tenant data storage 422). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more SQL statements (e.g., one or more SQL queries) that are designed to access the desired information. System data storage 424 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising;
computer code for receiving from a mobile device a request to access content;
computer code for automatically identifying an access token stored on the mobile device, based on the request; and
computer code for authenticating the mobile device for accessing the content, using the access token.

2. The computer program product of claim 1, wherein the request includes a uniform resource locator (URL).

3. The computer program product of claim 2, wherein the URL indicates the content.

4. The computer program product of claim 1, wherein the computer program product is operable such that the access token is included with the request, such that the access token is automatically identified from the request.

5. The computer program product of claim 1, wherein at least a portion of the access token is encrypted.

6. The computer program product of claim 1, wherein the computer program product is operable such that the access token is uniquely associated with the mobile device.

7. The computer program product of claim 1, further comprising computer code for generating the access token during a registration of the mobile device.

8. The computer program product of claim 7, wherein the registration of the mobile device includes a registration with a multi-tenant on-demand database system storing the content.

9. The computer program product of claim 7, wherein the computer program product is operable such that the access token is generated in response to receipt of a username and password from the mobile device during the registration.

10. The computer program product of claim 1, wherein the access token includes an identifier of a location of the content.

11. The computer program product of claim 10, wherein the identifier of the location is encrypted.

13. The computer program product of claim 10, wherein the location includes a server on which a plurality of different content is stored for access by the mobile device.

14. The computer program product of claim 10, wherein authenticating the mobile device includes identifying the identifier of the location of the content from the access token.

15. The computer program product of claim 10, further comprising computer code for forwarding the request to the location, in response to the authentication.

16. The computer program product of claim 15, wherein the computer program product is operable such that the request is forwarded for allowing a device at the location to provide a response to the request to the mobile device.

17. The computer program product of claim 1, wherein the computer program product is operable such that a session is established with the mobile device in response to the authentication.

18. The computer program product of claim 17, wherein the computer program product is operable such that a response to the request is sent to the mobile device utilizing the session.

19. A method, comprising:
receiving from a mobile device a request to access content;
automatically identifying an access token stored on the mobile device, based on the request; and
authenticating the mobile device for accessing the content, using the access token.

20. An apparatus, comprising:
a processor for:
receiving from a mobile device a request to access content;
automatically identifying an access token stored on the mobile device, based on the request; and
authenticating the mobile device for accessing the content, using the access token.

21. A method for transmitting code, comprising:
transmitting code to receive from a mobile device a request to access content;
transmitting code to automatically identify an access token stored on the mobile device, based on the request; and
transmitting code to authenticate the mobile device for accessing the content, using the access token.
